(19) United States
(12) Patent Application Publication
(10) Pub. No.: US 2017/0195250 A1
(43) Pub. Date: Jul. 6, 2017

(54) AUTOMATIC DATA RESTRICTIONS BASED ON SIGNALS

(71) Applicant: Google Inc., Mountain View, CA (US)

(72) Inventors: Sandeep Siddhartha, Seattle, WA (US); Douglas Brian Arnett, Seattle, WA (US); Juan Spiniak, San Francisco, CA (US)

(21) Appl. No.: 14/988,960

(22) Filed: Jan. 6, 2016

(51) Int. Cl. H04L 12/927; H04L 29/08

(52) U.S. Cl. CPC H04L 47/803; H04L 67/10

(57) ABSTRACT

According to an implementation of the disclosure, a data management application executing on a mobile device may receive from another application executing on the mobile device, a request to provide data via a network communication component of the mobile device to a server system that is remote from the mobile device. The data management application may determine that data limiting conditions associated with the requesting application have been satisfied. In response to the determination that the data limiting condition have been satisfied, the data management application may prevent access by the requesting application to the network communication component and present a prompt to a user that may allow the user to permit the requesting application to access the network.

### BACKGROUND

The cost of data access on mobile phones can be prohibitive for most users in the world. Users do not have access to convenient controls to limit the use of data by applications installed on their phone. Often users resort to manually turning off their cellular and wi-fi radios or selecting airplane mode. However, these options restrict data access for all of the applications installed on their mobile phone as well as disable telephony capabilities.

### BRIEF SUMMARY

According to an implementation of the disclosure, a first application executing on a mobile device may receive from a second application executing on the mobile device, a first request to provide a first data via a network communication component of the mobile device to a server system that is remote from the mobile device. The first application may determine that a data limiting condition associated with the second application has been satisfied. In response to the determination that the data limiting condition has been satisfied, the first application may prevent access by the second application to the network communication component.

According to another implementation of the disclosure, a mobile device may include a processor, a display, a network communication component, and a non-transitory, computer-readable medium in communication with the processor, the display, and the network communication component. The non-transitory, computer-readable medium may store instructions that when executed by the processor cause the mobile device to perform operations. The operations may include receiving, by the first application executing on the mobile device from a second application executing on the mobile device, a first request to provide a first data via the network communication component to a server system that is remote from the mobile device, and determining, by the first application, that a data limiting condition associated with the second application has been satisfied. The operations may also include in response to the determination that the data limiting condition has been satisfied, preventing, by the first application, access by the second application to the network communication component. The operations may also include, in response to the determination that the data limiting condition has been satisfied, providing, by the first application, a prompt on the display to allow a user to permit the second application to access a network connected to the mobile device.

According to another implementation of the disclosure, a non-transitory, computer-readable medium may store instructions that when executed by a processor of a mobile device cause the mobile device to perform operations. The operations may include receiving, at a first application executing on the mobile device from a second application executing on the mobile device, a first request to provide a first data via a network communication component of the mobile device to a server system that is remote from the mobile device. The operations may also include determining, by the first application, that a quantity of requests within a period of time to provide data to and/or from the second application via the network communication component exceeds a first threshold, and determining, by the first application, that a quality of service rating of a network to which the network communication component is connected exceeds a second threshold. The operations may also include, in response to the determination that the first threshold and the second threshold have been exceeded, preventing, by the first application, access by the second application to the network communication component.

Another implementation of the disclosure may include means for a first application executing on a device to receive from a second application executing on the device, a first request to provide a first data via a network communication component of the device to a server system that is remote from the device. An implementation may also include means for the first application to determine that a data limiting condition associated with the second application has been satisfied. An implementation may also include means for, in response to the determination that the data limiting condition has been satisfied, the first application to prevent access by the second application to the network communication component.

Additional features, advantages, and implementations of the disclosure may be apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide further understanding of the disclosure, are incorporated in and constitute a part of this specification. The drawings also illustrate implementations of the disclosure, and together with the detailed description serve to explain the principles of implementations of the disclosure. No attempt is made to show structural details in more detail than may be necessary for a fundamental understanding of the disclosure and various ways in which it may be practiced.

FIG. 1 shows a system architecture and the components of network service components according to an implementation of the disclosure.

FIG. 2 shows a sequence diagram for permitting an application to send data according to an implementation of the disclosure.

FIG. 3 shows a sequence diagram for preventing an application from sending data according to an implementation of the disclosure.

FIG. 4 shows a sequence diagram for permitting an application to send data according to an implementation of the disclosure.

FIG. 5 shows a sequence diagram for preventing an application from receiving data according to an implementation of the disclosure.

FIG. 6 shows a sequence diagram for permitting an application to receive data according to an implementation of the disclosure.

FIG. 7 shows a sequence diagram for preventing an application from receiving data according to an implementation of the disclosure.

FIG. 8 shows configuration options for data limiting conditions of a data management application according to an implementation of the disclosure.

FIG. 9 shows flow diagram of the transition of operating states of an application according to an implementation of the disclosure.

FIG. 10 shows a prompt for a user to block or allow an application to access a network according to an implementation of the disclosure.

FIG. 11 shows a prompt for a user to allow or continue to block an application's access a network according to an implementation of the disclosure.

FIG. 12 shows a flow diagram for a process for automatically blocking or allowing an application to send or receive data over a network according to an implementation of the disclosure.

FIG. 13 shows, according to an implementation of the disclosure, a flow diagram for a process for automatically blocking or allowing an application to send or receive data over a network based on conditions, including the operating state of the application.

FIG. 14 shows, according to an implementation of the disclosure, a flow diagram for a process for automatically blocking or allowing an application to send or receive data over a network based on conditions, including the response of a user to a prompt.

FIG. 15 shows a computing device, according to an implementation of the disclosure.

FIG. 16 shows a network arrangement, according to an implementation of the disclosure.

### DETAILED DESCRIPTION

Implementations of the disclosure may provide for a data management application that may restrict access to a data network by certain applications on a mobile device based on certain conditions. For example, the data management application may control access by other applications on a mobile device to a network device driver. The network device driver may interface with a network communications component, such as a wi-fi or cellular radio that provides access to the data network. A user may configure the data management application to restrict a certain application's access the network based on certain conditions. For example, a user may select a configuration that prevents an application (for example, a second application) from accessing the network when it is executing in the background and the mobile device has used over 90% of the total data it has available. When the application makes a request to transmit data, the data management application may receive the request and determine the requesting application is executing in the background, and the data usage is over the 90% threshold. As a result, the data management application may prevent the request of the requesting application from reaching the network communications component.

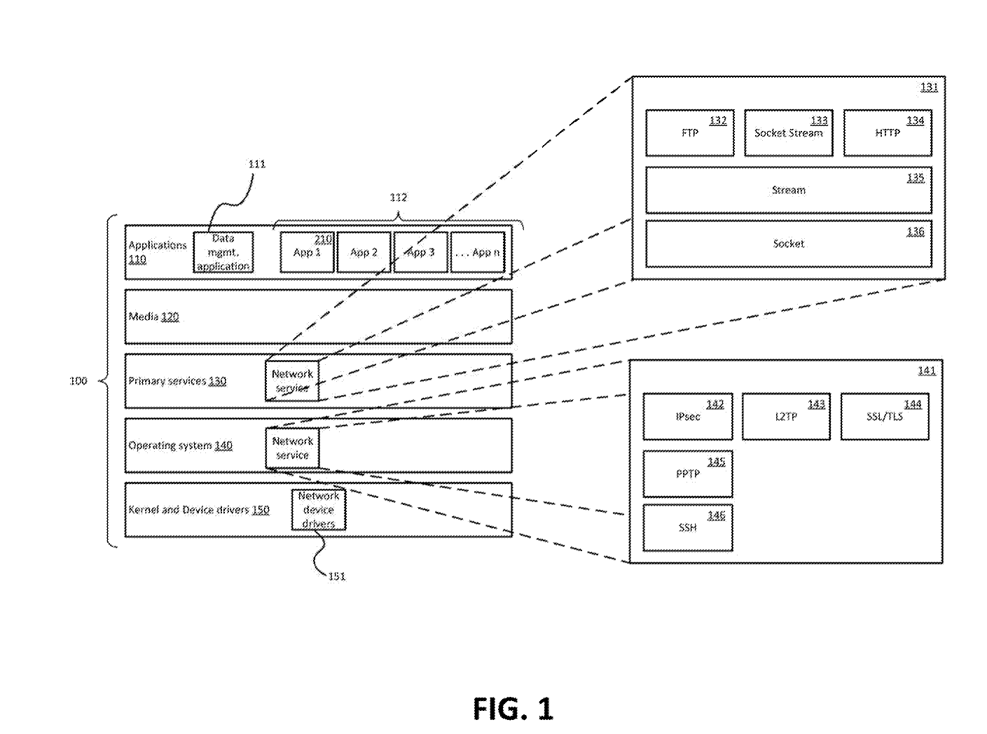

Implementations of the disclosure may be realized in a variety of component architectures. For example, FIG. 1 shows system architecture 100 having applications layer 110, media layer 120, primary services layer 130, operating system layer 140, and kernel and device driver layer 150, according to an implementation of the disclosure. The components depicted in architecture 100 may be implemented on a device such as a mobile phone, smart phone, tablet computer, personal computer, lap top, smart watch or related wearable device, and similar mobile and non-mobile devices. Architecture 100 is exemplary only, and implementations of this disclosure may be realized in various other architectures suitable for the purposes of this disclosure.

Applications layer 110 may contain data management application 111, which may also be referred to as a first application. Applications layer 110 may also contain other applications 112 executing within architecture 100, any of which, for example, may be referred to as a second application. For example applications 112 may include email applications, calendar applications, web browsing applications, mapping applications, social media applications, web encyclopedia applications, weather applications, banking applications, mapping applications, remote storage applications, podcasting applications, photo sharing applications, video and audio streaming applications, taxi service applications, or any other applications that may execute on a computing device.

Components of media layer 120 may provide media services for applications of applications layer 110. For example, media layer 120 may include photo, 2D and 3D drawing and graphics, animation, and audio services. Primary services layer 130 may include services that support certain core functions of applications 110. For example, primary services 130 may include services for validating and accessing user accounts; contact information; accessing integrated cloud storage and local database storage; global positioning system (GPS), cellular, and wi-fi-based location; telephony; social media account management; in-application purchasing; and system configuration. Components of primary services layer 130 may also include network services 131 for interacting in accordance with network protocols over communications components of a mobile device. For example, network service 131, may include services for using Berkeley Software Distribution (BSD) sockets, interacting with HTTP servers, resolving DNS hosts, and interacting with HTTP servers.

Components of operating system layer 140 may support low-level features upon which other components of architecture 100 depend. For example, operating system layer 140 may include services for enabling communications with other hardware devices, performing digital signal processing, and hardware optimization. Operating system layer 140 may also include services for secure communications such as credential management, local authorization, management of trust policies, and establishing communications over a virtual private network (VPN) connections. For example, network service 141, may include VPN services for creating encrypted connections using internet protocol security (IPSec) 142, layer 2 tunneling protocol (L2TP) 143, secure sockets layer (SSL) or transport layer security (TLS) service 144, point-to-point tunneling protocol (PPTP) 1345, or secure shell (SSH) protocol 146.

When VPN services are executing they may control some or all network access for components of architecture 100, including access by applications 112. VPN services may be configurable to selectively require certain applications to send and receive traffic through an established VPN and allow other applications to use a network connection outside the VPN, such as a local wireless access network (WLAN). Elements of a VPN service may be configured independently of establishing an actual VPN connection. For example, a VPN service may require an application to route its data traffic through the VPN yet no VPN may exist over which the traffic can be transmitted. Thus the routed traffic may be dropped and as a result the application may be denied network access.

The data management application 111 may have a dependency on or otherwise interact with a VPN service to selectively choose which applications may be required to route their network traffic to a non-established VPN. In this way, data management application may block an application from sending or receiving data over a network connection. The routing may be based on data limiting conditions such as those discussed throughout this disclosure When data limiting conditions are not satisfied, an application's data traffic may be permitted to access normal network channels, such as those via network service 131. Further aspects of data management application 111 are discussed throughout the disclosure.

Network service 141 may also include services unrelated to VPN services. For example network service 141 may include a service specifically configured control access to data sent or received to or from networks connected to the device implementing architecture 100. Such a network service may implement a set of user-selected policies that specify when each of applications 112 may access data over a network. Thus rather than routing data based on VPN requirements, network service 141 may deny access to network communications components or network device drivers in accordance with policies selected by a user. Network service 141 may be an element of the operating system of architecture 100 or it may be a service supporting a data management application such as data management application 111.

Kernel and device driver layer 150 may include system level resources that support aspects of the operating system of architecture 100. For example, kernel and device drive layer 150 may manage the file system, virtual memory allocation, threads, and interprocess communications of the device implementing architecture 100. Layer 150 may also include device drivers for hardware components of the device in which architecture 100 is implemented. Device drivers may interface with hardware components such as video adapters, sound cards, and network cards. For example, network device driver 151 may interface between components of architecture 100, such as network service 140, and hardware network communications components such as cellular, and near field communication and BLUETOOTH technology radios.

Data management application 111 may interact with applications 112, network service 131, network service 141, and network device drivers 151 to manage data usage by applications 112. For example, data management application 111 may present a user the option of selecting conditions under which a particular application, such as a social media application may access a network connection. A social media application may continuously monitor the social media postings of the user's contacts and download their postings onto the user's device. The user may not wish to use her data balance during the evenings because she is sleeping and not available to read the posts. She may not want to use her data balance when the social media application is running in a background state because she is not concerned with new social media data when she is not using the application. The user may also not want to use her data for the application when she has used over 90% of her available data balance because she would rather conserve her data for more critical applications such as her email or banking applications. The user may select conditions that, when satisfied, deny the social media application access to the network during the user's normal sleeping hours, when the application is running in a background state, and whenever 90% of her current data balance has been used.

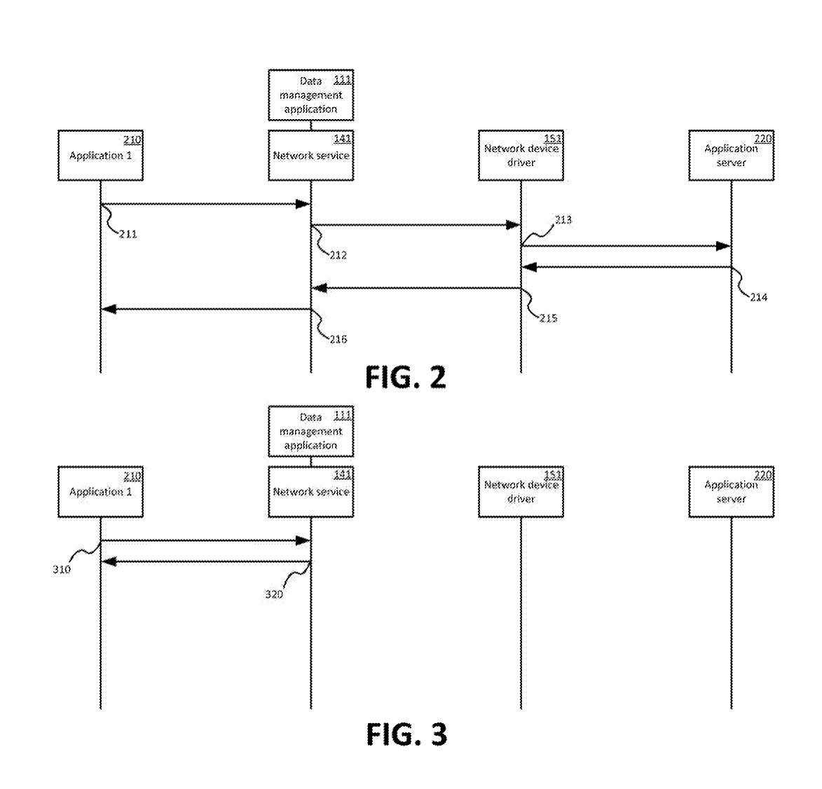

Unless the conditions set by the user are satisfied, the social media application may send and receive data over a network connected to the user's device. For example, FIG. 2 shows a sequence diagram for permitting an application to send data according to an implementation of the disclosure. As shown, application 210 may be the user's social media application. At 211, application 210 may request status update information from application server 220, which may be remote from the user's device. At 212 components of network service 141 may receive the request from application 210 and provide an indicator of the request to data management application 111.

Data management application 111 may determine that no data limiting condition has been satisfied for application 210. For example the data management application 111 may query the amount of data used by the user's device, the operating state of application 210, and the date and time of the status update request. The data management application 111 may determine that the user's device has not used more than 90% of its data balance, that the social media application is operating in the foreground state, and that it is 11:30 am on a Tuesday. Based on this query, the data management application may determine that the user's data limiting conditions for this application have not been met, and thus at 212, data management application 111 may permit the request from application 210 to proceed to network device driver 151. At 213 network device driver 151 may provide the request to a network communications component of the user's device, which may transmit the request to application server 220.

At 214 the application server 220 for the social media application may determine updated statuses for the user's social media contacts and at 214 provide the updated status data to the user's device via network device driver 151. At 215, the network device driver may provide the updated status data to the network service 141, which may provide an indicator of the updated status data to data management application 111. The data management application may determine that no data limiting conditions are satisfied in accordance with the techniques described above with respect to the initial request by the social media application. As a result, data management application 111 may permit the response from application server 220 to be provided by network service 141 to application 210 at 216. In some implementations, data management application 111 may only filter data transmission requests from applications 112 and not monitor incoming data transmissions such as the status update 214.

At a later time, data limiting conditions for the social media application may be satisfied. For example, FIG. 3 shows a sequence diagram for preventing an application from sending data according to an implementation of the disclosure. As above, at 310 the social media application 210 may request status updates from application server 220. The request may be received by network service 141, which may provide an indicator of the request to data management application 111. The request at 310 may be made at 11:30 pm later the same Tuesday. This may be within the user's specified sleeping schedule, and thus the data management application 111 may determine that a data limiting condition for application 210 has been satisfied. Based on this determination, data manage application 111 may prevent network service 141 from providing the request to the network device driver 151. At 320 data management application 111 may provide a response to the social media application that indicates that it is not permitted to access the data network at this time.

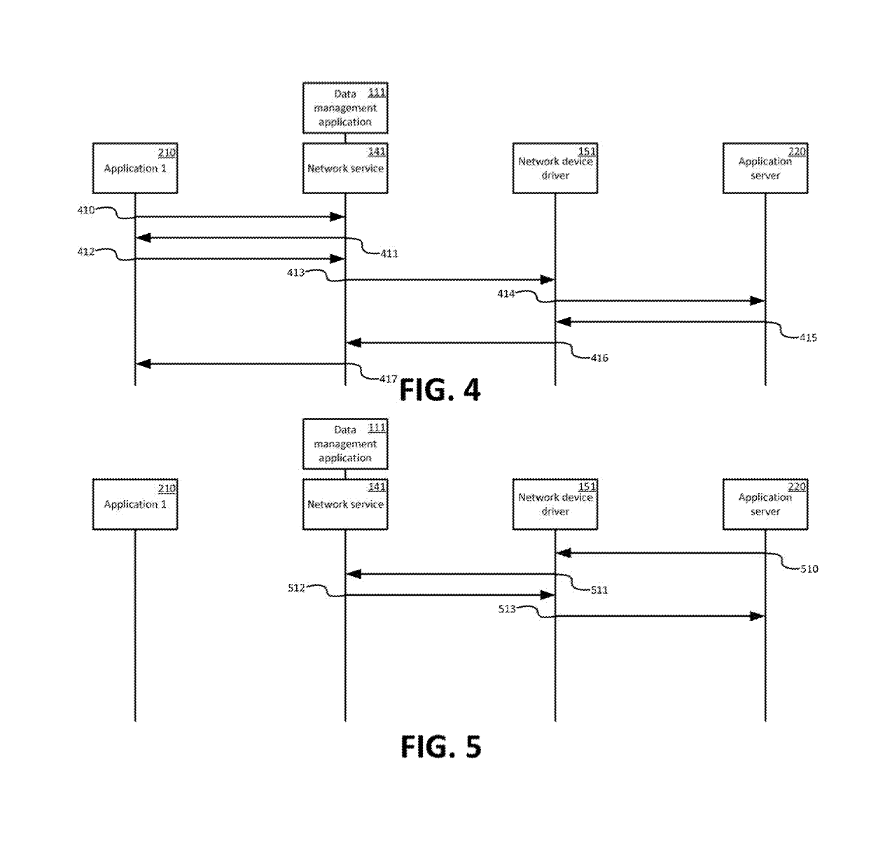

In some implementations, a data limiting condition for an application may be met, and rather than automatically blocking the application, the data management application may present a prompt to the user requesting that the user authorize access. For example, FIG. 4 shows a sequence diagram for permitting an application to send data according to an implementation of the disclosure. At 410 social media application 210 may request status updates from application server 220. Network service 141 may receive the request and provide an indicator of the request to data management application 111. Data management application 111 may determine that data limiting conditions have been met, and at 411 provide a prompt to appear on the user's device within or overlapping application 210. The user may view the prompt and select to allow the application to access the data network. At 412 the user's selection may be provided to the data management application 111. In response to receiving the user's authorization, at 413 data management application 111 may permit network service 141 to provide the status request to the network device driver 151. The network device driver may then cause the network communications component of the user's device to transmit the request to the application server 220 at 414.

At 415 the application server may transmit a response to the request to the network device driver 151, which may provide the response to network service 141 at 416. Data management application 111 may determine the response is a result of the previously authorized request. For example data management application may 111 determine that an identifier included in the request is also present in the response. The user's authorization 412 may also indicate a time period during which data transmission may be permitted for social media application 210. Data management application 111 may determine the response from the application server 220 was received with this time period. Based on either of these determinations or other determinations suitable for the purposes of the disclosure, at 417 data management application 111 may permit network service 141 to provide the status updates to application 210.

In some circumstances, data may be provided to an application from a remote source when the user does not wish to receive data. For example, FIG. 5 shows a sequence diagram for preventing an application from receiving data according to an implementation of the disclosure. At 510, remote application server 220 may send a status update to the user device that is received at network device driver 151. Network service 141 may receive the update and provide an indicator of the update to data management application 111. Data management application 111 may determine that a data limiting condition for the application has been met and prevent network service 141 to from providing the status update to social media application 210. At 512 data management application may cause network service 141 to provide a notice indicating application 210 is not currently authorized to receive data. At 513 network device driver 151 may transmit this notice, via a network communications component to the application server 220.

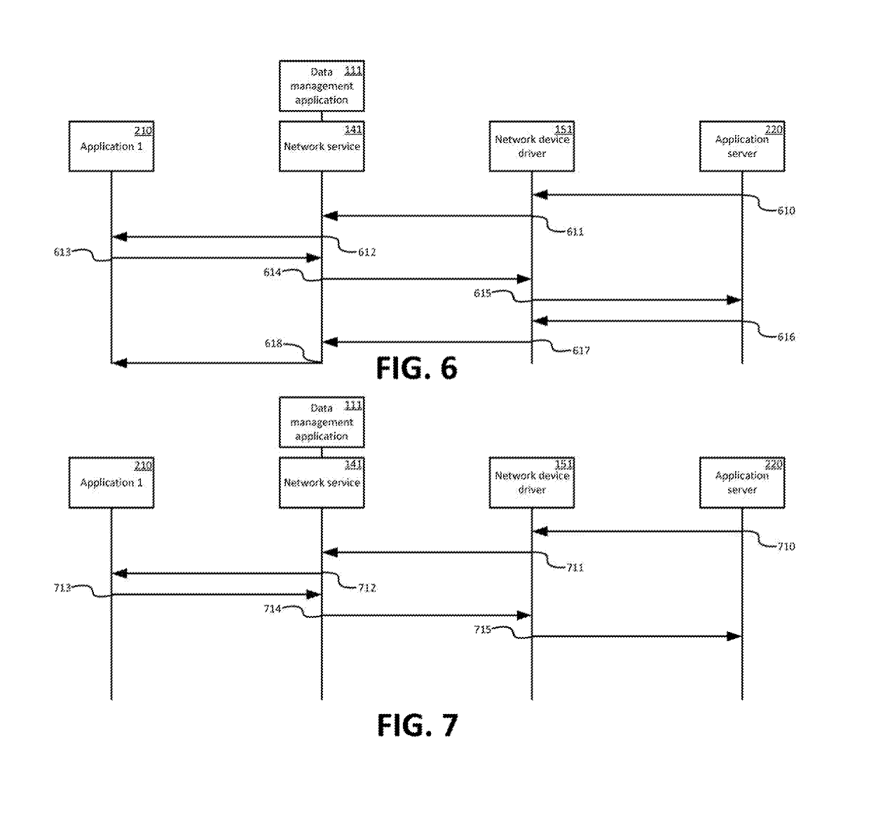

Although a user may generally not want her social media application to receive status updates, she may want to selectively allow the application to accept data. For example, rather than general status updates, one of her social media contacts may want to send a photo to her device. Before accepting the download on her device, the user may be presented with a prompt requesting authorization to download the photo. FIG. 6 shows a sequence diagram for permitting an application to receive data according to an implementation of the disclosure. At 610 the application server 220 may transmit a request indicating that a social media contact of the user wants to send the user a photo. The network device driver 151 may receive the request and at 611 provide the indicator to the network service 141. The network service 141 may provide an indicator of the request to the data management application 111, and data management application 111 may determine that a data limiting condition has been satisfied. As a result, the data management application 111 may provide a prompt 612 via the user interface of the user's device that displays over or within social media application 210. The user may select that she wants to download the picture, and at 613 an indicator representing the user's selection may be provided to the data management application 111. At 614, in response to receiving the user's selection, the data management application 111 may provide a request to the application server 220 to begin downloading the picture. The network service 141 may provide the request to the network device driver 151, which may transmit the request via a network communications component of the user's device at 615. At 616 the application server 220 may transmit the picture to the users device. The download may be received at network device driver 151, which may provide the picture to network service 141 at 617. Network service 141 may provide an indicator of the download to data management application 111, which may determine that no data limiting conditions are satisfied. Data management application 111 may then permit network service 141 to provide the picture to social media application 210 at 618.

In response to receiving a prompt, a user may also choose not to allow data access for an application. For example, FIG. 7 shows a sequence diagram for preventing an application to receive data according to an implementation of the disclosure. Application server 220 may transmit a request to download a picture onto the user's device. At 710, 711, and 712, similar processes may take place as with respect to 610, 611, and 612. However, at 713 the user may select not to download the picture from her social media contact. The user's selection may be provided to the network service 141 at 713, and network service 141 may provide an indicator of the selection to data management application 111. At 714, data management application 111 may direct network service 141 to provide a notice to the application server 220. The network device driver 151 may receive the notice and may transmit the notice to the application server 220 at 715. Based on the notice, application server 220 may refrain from transmitting the picture to the user's device.

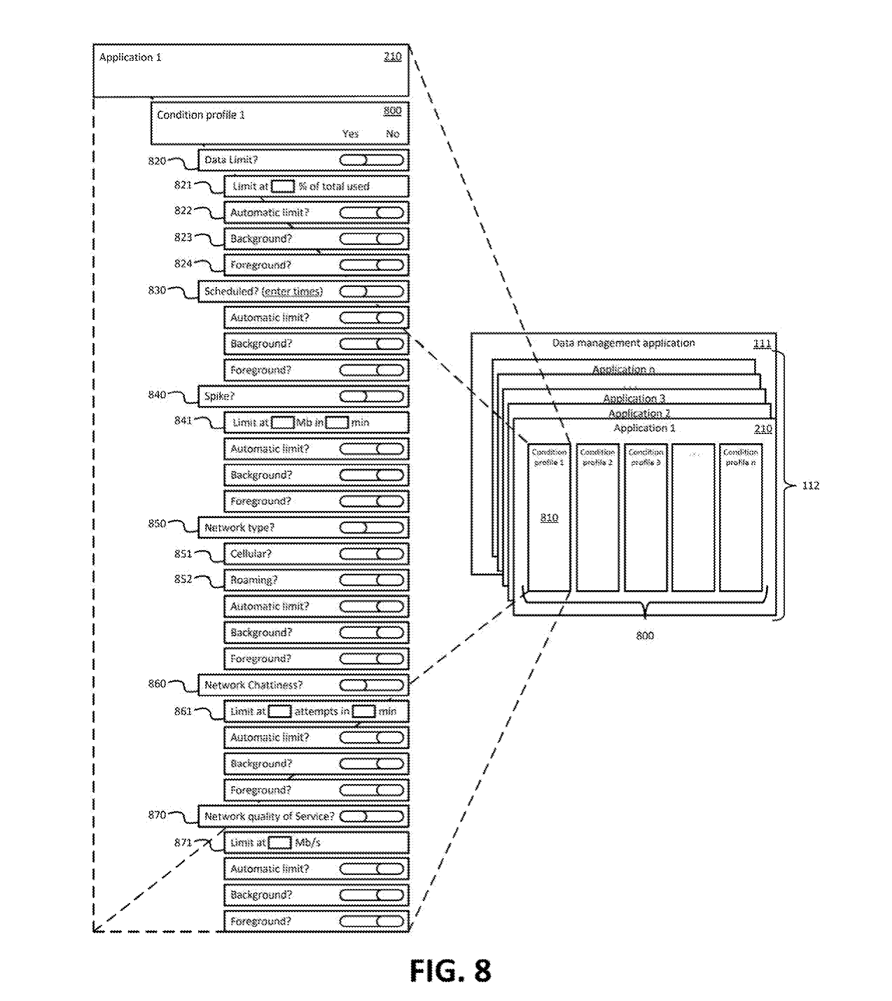

Data management application 111 may provide for multiple data limiting conditions for multiple applications. For example, FIG. 8 shows configuration options for data limiting conditions of a data management application according to an implementation of the disclosure. As shown, data management application 111 may contain configuration options for each of the set of applications 112. Each application may have a set of condition profiles. For example, social media application 210 may be associated with a set of condition profiles 800 including condition profile 810.

Each condition profile may provide various options for configuring data limiting conditions. For example, condition profile 800 may allow for data limiting conditions based on a selected data limit 820, a scheduled time period 830, a quantity of data transferred within a period of time (spike) 840, a type of network to which the user's device is connected 850, a quantity of network connection attempts by application 210 within a period of time (chattiness) 860, or a quality of service of a network 870.

Each data limiting option may have further condition specifications. For example, if the user wishes to limit data access based on a data limit 820, then the user may specify what percentage 821 of the user's total data balance can be the threshold level. The user may choose whether the limit triggers an automatic restriction or whether the user is otherwise prompted 822. The user may specify whether the data limiting condition is satisfied when application 210 is executing in the background 823, the foreground 824, or both.

If the user wishes to limit data access for social media application 210 based on a quantity of data in a period of time, the user may specify that data spike condition 840 restricts data access at a threshold when a certain number of megabits are used by the application within a certain number of minutes 841. The threshold may also be set for total data usage by some or all applications on the device within a certain time period. The user may wish to trigger data limiting for application 210 based on the type of network to which the user's device is connected. For example, the user may specify data restrictions when the device is connected to a cellular network 851 or the device is using a roaming data network 852. If application 210 makes frequent attempts to access the network, then the user may select a condition that restricts the access of application 210 to the network whenever the application exceeds a specified number of access attempts in a specified number of minutes 861. The user may also choose to restrict data access by an application when a certain number of network access attempts are made by some or all applications on the user's device within a certain period of time. Similarly, the user may specify that application 210 may not access the network unless the network's quality of service indicates download speeds of at least a specified number of megabits per second 871. Implementations may realize other data limiting conditions suitable for the purposes of the disclosure. For example, data access for an application may be limited based on a quantity of total data passing through the network in a period of time, a quantity of packets dropped by the network in a period of time, a quantity of blocked network connection attempts in a period of time, a quantity of queue delay in the network in a period of time, a net bit rate of the network, a signal strength of the network, or other data limiting conditions suitable for the purposes of the disclosure.

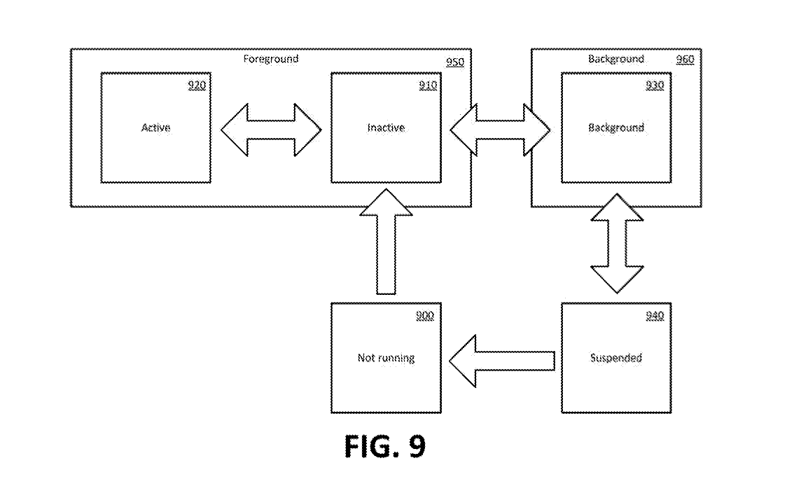

Applications may execute within various states within architecture 100. A user may wish to specify data limiting conditions for an application based on its operating state. For example, FIG. 9 shows flow diagram of the transition of operating states of an application according to an implementation of the disclosure. An application, such as social media application 210, may initially not be running and thus be in the not running state 900. If the application is launched then the application may transition into the inactive state 910, within foreground 950. The inactive state may be a short-lived, transitionary state between either active state 920 or background state 930. When the application is in an active state 920, a user may not wish to limit data access for the application because the active state 920 may be the general operational state for an application when the user is interacting with it. The user may want the application to have full functionality, which may include access to data.

However, when the application transitions to background state 930 within background 960, the user may wish to limit data access for the application. Background state 930 may allow an application to continue executing instructions while other applications are executing in the foreground. For example, an application, such as social media application 210, may execute in the background state 930 to download social media updates for a user's contacts, while the user is reading her email in the foreground 950. Users may not wish to allow applications to access a data network while executing in the background 960 because execution in the background generally may indicate the user is not interacting with the application at that time. Once an application completes executing all of its instructions, it may transition to suspended state 940. The state transition arrangement shown in FIG. 9 is exemplary only, and implementations of this disclosure may interact with other arrangements suitable for the purposes of this disclosure.

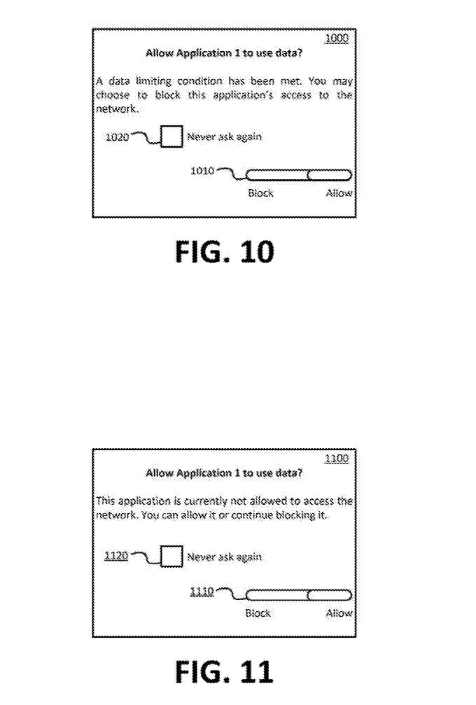

When data limiting conditions are met for an application, data management application 111 may automatically restrict the application's access to data or it may present the user a prompt to allow the user to allow the application to access the data network. For example, FIG. 10 shows a prompt 1000 for a user to block or allow an application to access a network when a data limiting condition is first met, and FIG. 11 shows a prompt 1100 for a user to allow or continue to block an application's access a network based on the satisfaction of pre-existing data limiting conditions. At 1010 and 1110, a user may be presented with a control toggle that permits the user to block or allow data access for an application. At 1020 and 1120, a user may be presented with a check box to make the user's selection permanent with respect to the particular data limiting condition that had been met. A prompt may also allow the user to block or allow an application's data access for a limited amount of time, for example 5 minutes.

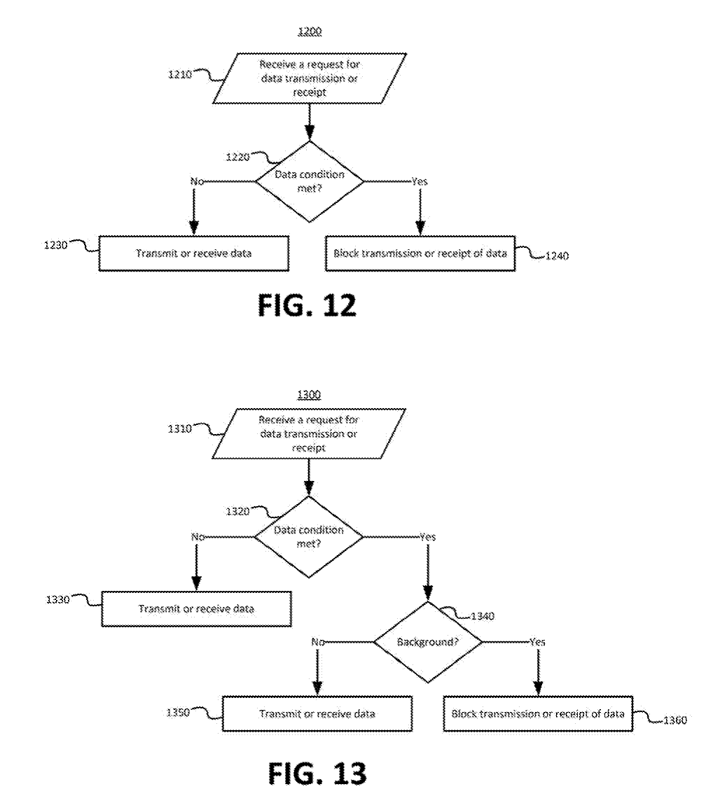

The techniques for limiting an application's access to data networks may be implemented according to various methods. For example, FIG. 12 shows a flow diagram for a process 1200 for automatically blocking or allowing an application to send or receive data over a network according to an implementation of the disclosure. Data management application 111 may receive a request for data transmission or receipt by an application at 1210. For example social media application 210 may request access to upload a status update for an account associated with the user. At 1220, the data management application 111 may query aspects of the device on which the data management application is executing to determine whether a data limiting condition is met. For example, the data management application 111 may determine that the request to upload the status update was based on operation of the application in the background. The application may periodically update the user's location data in their social media status based on received GPS data. This location updating process may execute in the background.

If no data limiting condition is met, then at 1230 the data management application may permit the application to send or receive data. If a data limiting condition is met, then at 1240, the data management application may prevent the application from sending or receiving data. For example, the data management application 111 may associate a data limiting condition with the social media application 210, which prevents data access when the social media application 210 is operating in the background. Based on determining the status update request was associated with a background operation, data management application 111 may prevent the request from reaching a network communications component of the user's device.

Data management application 111 may also use other bases for determining whether an application may access the network. For example, data management application 111 may determine that a user is not interacting with an application making a request to access the network. For example, the requesting application may not be executing instructions that interact with the user interface or audio components of the user's device. Based on this determination, the data management application 111 may restrict the application's access to the data network. Similarly, any combination of the configuration options discussed above, such as with respect to FIG. 8 may serve as a basis for a data limiting condition.

If the data management application 111 restricts the application's 210 access to the data network 1240, it may receive at a later time, a second request from the application 210 to access the data network. The later request may be determined by the data management application 111 to be associated with the user interface of the user's device. For example the data management application 111 may determine that the data requested in the second request is associated with an update of a visual indicator on the user interface. Based on this determination, the data management application may provide a prompt the user, such as that described with respect to FIGS. 10 and 11. The prompt may allow the user to select whether she wants to transmit the data indicated in the second request. The user may choose to allow the transmission by indicating her preference via the prompt. Data management application 111 may receive this selection and permit the application to request the update data.

Multiple conditions may need to be satisfied to satisfy a single data limiting condition. For example, FIG. 13 shows, according to an implementation of the disclosure, a flow diagram for a process 1300 for automatically blocking or allowing an application to send or receive data over a network based on a condition having multiple components. At 1310 data management application 111 may receive a request to transmit or receive data, and at 1320 may determine whether a first component of a data condition is met. For example, the data management application 111 may determine whether the application had attempted to access the network more than a threshold number of times within a specified time period. If the application had not exceeded the threshold, then at 1330, the data management application 111 may permit the application to access the network. If the application had exceeded the threshold, then at 1340, the data management application may determine whether the second data limiting component was met. For example the second component may include whether the application was operating in the background at the time of the request. If the application was not operating in the background, then at 1350, the data management application 111 may permit the application to access the network. If the second component was met, then at 1360 the application may be restricted from accessing the network.

Other combinations of conditions as components of a data limiting condition may also be contemplated. For example a data limiting condition may include both a network connection type and a data transmission rate or reception rate of a network to which the mobile device is connected. As another example a data limiting condition may include determining that a quantity of requests by an application to access the network within a period of time has exceeded a specified threshold and that a quality of service rating for the network to which the user's device is connected had exceeded another threshold. In response to these determinations, the data management application 111 may prevent the requesting application's access to a network communication component.

Depending on the type of condition, a threshold may be exceeded if a measured quantity falls below or above a threshold quantity. For example a threshold may be exceeded and a condition satisfied if a network data transmission rate quantity is less than a threshold quantity, or a threshold may be exceeded and a condition satisfied if a quantity of network connection requests is greater than a threshold quantity.

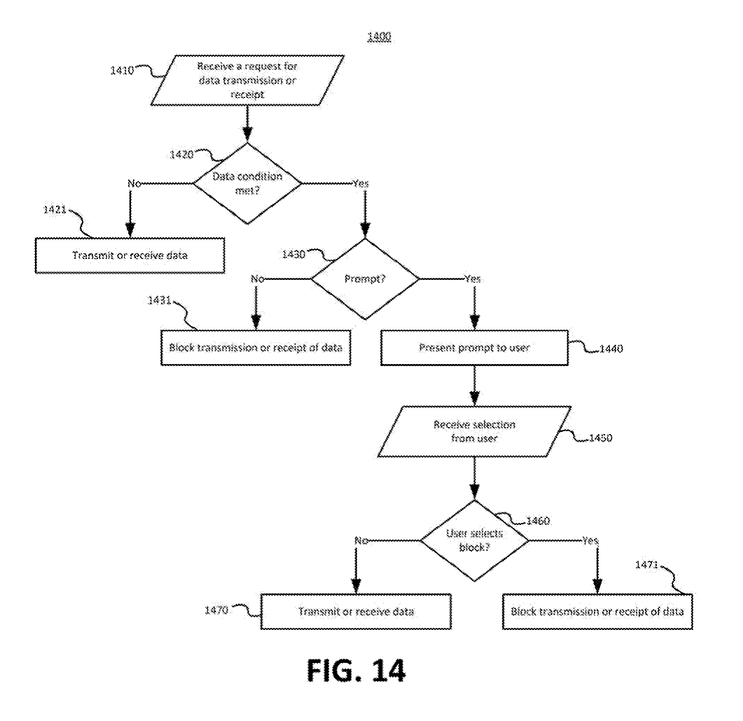

Implementations of the disclosure may include a device, such as a mobile device that includes a processor, a display, a network communications component, and a non-transitory, computer-readable medium in communication with the processor, display, and network communications component. Such components may implement any of the methods disclosed herein. For example, a mobile device may implement the method shown in FIG. 14.

FIG. 14 shows, according to an implementation of the disclosure, a flow diagram for a process 1400 for automatically blocking or allowing an application to send or receive data over a network based on a response of a user to a prompt and conditions, including the operating state of the application. For example, data management application 111 may be installed on the mobile device and receive a request from an application on the device to provide data to a remote server system via the network communication component at 1410. The data management application 111 may determine whether a data limiting condition has been met at 1420. If no component of a data limiting condition has been met, data management application 111 may permit the requesting application to provide data to the remote server system at 1421. If a component of a data limiting condition has been met, then the data management application 111 may determine where there are additional components to the data limiting condition at 1430, such as a user prompt. If there are no further data limiting conditions, then the data management application 111 may prevent the application from accessing the network at 1431. If there are further data limiting conditions, such as the user prompt, then at 1440 the data management application 111 may present the prompt to the user on the display of the device and receive the user's selection to either allow or block the application's access at 1450. At 1460, the data management application 111 may determine whether the user has selected to allow or block the data access. If the user has selected to allow access, then at 1470 the requesting application may be permitted to access the network communication component and thereby transmit or receive data over the network. If the user has selected to block access, then at 1471 the data management application may prevent access to the network.

Implementations of the disclosure may interface with other components and devices both within and external to the user's device. For example, the data management application 111 may interact with a server system operated by the provider of the network to which the user's device is connected. This interaction may be through an API that allows the data management application 111 to access data related to the user's account with the network provider, such as the data balance for the user's device and the amount of data sent and received over the network in a specified period of time. Data management application 111 may receive from the provider, data indicating the amount of data used by the user's device, and based on that quantity, determine the percentage of the total data balance used by the user's device. For example, if 1 GB of data has be used of a total data of 1.2 GB, then 1/1.2-84% of the total data balance has been used. The data management application 111 may have a data limiting condition that is satisfied if 85% of the total data balance has been used. As a result, the data management application may permit the application to access the network.

In another example, the data management application 111 may access account data on the user's device to determine the amount of data purchased for the user's device. The data management application 111 may also monitor the data usage of all applications on the device based on summing the quantities allocated with each application's data request. This sum may be divided by the purchased data quantity to determine a percentage used. The data management application may maintain a data limiting condition based on a threshold percentage of use of purchased data. The data management application 111 may update the calculated percentage each time an application submits a data access request. If the quantity of data sent and/or received by the mobile device exceeds the threshold quantity, the data management application may restrict a requesting application's access to the data network.

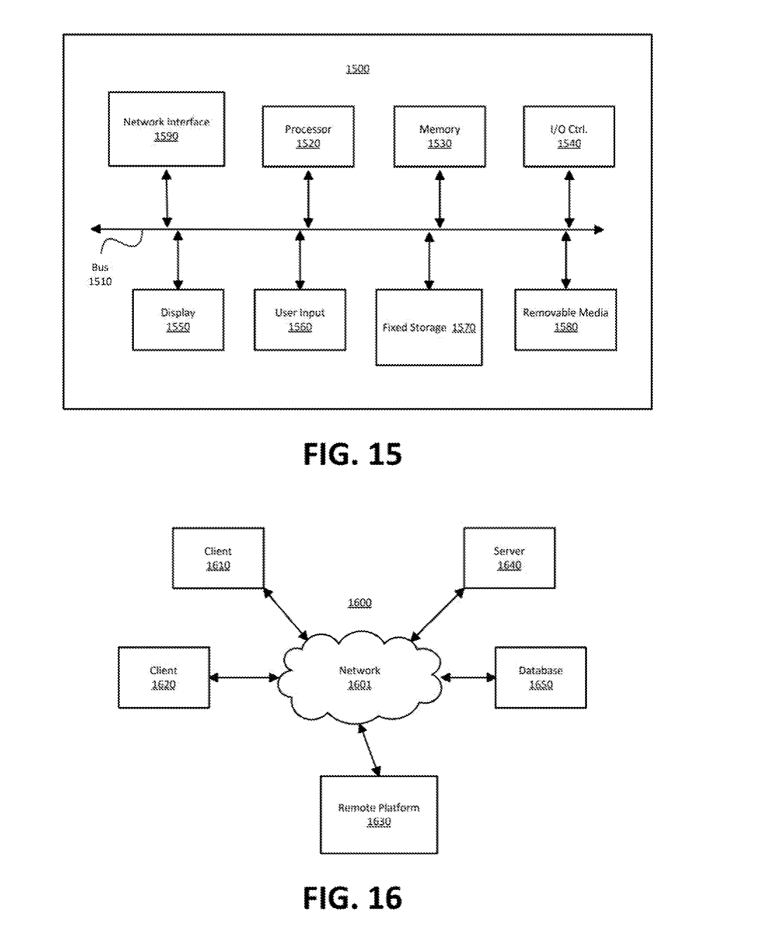

Implementations of the disclosure may be implemented in and used with a variety of component and network architectures. FIG. 15 is an example computing device 1500 suitable for implementations the disclosure. Computing device 1500 may be, for example, a computer. The computing device 1500 includes a bus 1510 which interconnects major components of the computing device 1500, such as a central processor 1520, a memory 1530 (typically RAM, but which may also include ROM, flash RAM, or the like), an input/output (I/O) controller 1540, a user display 1550, such as a display screen via a display adapter, a user input interface 1560, which may include one or more controllers and associated user input devices such as a keyboard, mouse, and the like, and may be closely coupled to the I/O controller 1540, fixed storage 1570, such as a hard drive, flash storage, Fibre Channel network, SAN device, SCSI device, and the like, and a removable media component 1580 operative to control and receive an optical disk, flash drive, and the like.

The bus 1510 allows data communication between the central processor 1520 and the memory 1530, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computing device 1500 are generally stored on and accessed via a computer-readable medium, such as a hard disk drive (e.g., fixed storage 1570), an optical drive, floppy disk, or other non-transitory or transitory computer-readable storage medium.

The fixed storage 1570 may be integral with the computing device 1500 or may be separate and accessed through other interfaces. A network interface 1590 may provide a direct connection to a remote server via a telephone link, to the Internet via an internet service provider (ISP), or a direct connection to a remote server via a direct network link to the Internet via a POP (point of presence) or other technique. The network interface 1590 may include network device drivers and may provide connections using wireless techniques, including digital cellular telephone connection, Cellular Digital Packet Data (CDPD) connection, digital satellite data connection or the like. For example, the network interface 1590 may allow the computing device to communicate with other computing devices via one or more local, wide-area, or other networks, as shown in FIG. 16.

Many other devices or components (not shown) may be connected in a similar manner (e.g., document scanners, digital cameras and so on). Conversely, all of the components shown in FIG. 15 need not be present to practice the present disclosure. The components can be interconnected in different ways from that shown. The operation of a computing device such as that shown in FIG. 15 is readily known in the art and is not discussed in detail in this application. Code to implement the present disclosure can be stored in computer-readable storage media such as one or more of the memory 1530, fixed storage 1570, removable media 1580, or in a remote storage location.

FIG. 16 shows an example network arrangement 1600 according to an implementation of the disclosure. One or more clients 1610, 1620, such as local computers, smart phones, tablet computing devices, and the like may connect to other devices via one or more networks 1601. The network 1601 may be a local network, wide-area network, the Internet, or any other suitable communication network or networks, and may be implemented on any suitable platform including wired and/or wireless networks. The clients may communicate with one or more servers 1640 and/or databases 1650. The devices may be directly accessible by the clients 1610, 1620, or one or more other devices may provide intermediary access such as where a server 1640 provides access to resources stored in a database 1650. The clients 1610, 1620 also may access remote platforms 1630 or services provided by remote platforms 1630 such as cloud computing storage and processing services. The remote platform 1630 may include one or more servers 1640 and/or databases 1650.

More generally, various implementations of the disclosure may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine-readable storage medium, wherein, when the computer program code is loaded into and executed by a computing device, the computing device becomes an apparatus for practicing implementations of the disclosure. Implementations also may be implemented in the form of computer program code, for example, whether stored in a storage medium, loaded into and/or executed by a computing device, or transmitted over some transmission medium, such as over electrical wiring or cabling, through fiber optics, or via electromagnetic radiation, wherein when the computer program code is loaded into and executed by a computing device, the computing device becomes an apparatus for practicing implementations of the disclosure.

When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Implementations may be implemented using hardware that may include a processor, such as a general purpose microprocessor and/or an Application Specific Integrated Circuit (ASIC) that implements all or part of the techniques according to implementations of the disclosure in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosure.

In situations in which the implementations of the disclosure may collect personal information about users, or may make use of personal information, the users may be provided with an opportunity to control whether programs or features collect user information (e.g., a user's game score, a user's work product, a user's provided input, a user's geographic location, and any other similar data associated with a user). User's may also be provided with an opportunity to control whether and/or how to receive shared content that may be relevant to the user. In addition, certain data may be treated in one or more ways before it is stored or used, so that personally identifiable information is removed. For example, a user's identity may be treated so that no personally identifiable information can be determined for the user, or a user's geographic location associated with social network information may be generalized where location information is obtained (such as to a city, ZIP code, or state level), so that a particular location of a user cannot be determined. Thus, the user may have control over how information is collected about the user and used by content distribution systems, social network systems, content developers, or other systems having access to the user's personal information.

The foregoing description, for purpose of explanation, has been described with reference to specific embodiments. However, the illustrative discussions above are not intended to be exhaustive or to limit implementations of the disclosure to the precise forms disclosed. Many modifications and variations are possible in view of the above teachings. The implementations were chosen and described in order to explain the principles of implementations of the disclosure and their practical applications, to thereby enable others skilled in the art to utilize those implementations as well as various implementations with various modifications as may be suited to the particular use contemplated.

1. A method comprising:
receiving, by a first application executing on a mobile device from a second application executing on the mobile device, a first request to provide a first data via a network communication component of the mobile device to a server system that is remote from the mobile device;
determining, by the first application, that a data limiting condition associated with the second application has been satisfied; and
in response to the determination that the data limiting condition has been satisfied, preventing, by the first application, access by the second application to the network communication component.

2. The method of claim 1, further comprising:
prior to preventing access by the second application to the network communication component, determining, by the first application, that the first request to provide the first data is associated with an operation of the second application executing in a background state.

3. The method of claim 1, further comprising:
prior to preventing access by the second application to the network communication component, determining, by the first application, that the user is not interacting with the second application.

4. The method of claim 1, further comprising:
prior to preventing access by the second application to the network communication component, determining, by the first application, that the first request to provide the first data is associated with an operation of the second application executing in a background state; and
receiving, by the first application from the second application, a second request to provide second data via the network communication component to the server system;
determining, by the first application, that the second request is associated with a user interface of the second application;
in response to determining the second request is associated with the user interface, providing, by the first application, a prompt to a user of the mobile device to allow access by the second application to a network connected to the mobile device.

5. The method of claim 1, further comprising:
prior to preventing access by the second application to the network communication component, determining, by the first application, that the first request to provide the first data is associated with an operation of the second application executing in a background state;
receiving, by the first application from the second application, a second request to provide second data via the network communication component to the server system;
determining, by the first application, that the second request is associated with a user interface of the second application;
in response to determining the second request is associated with the user interface, providing, by the first application, a prompt to a user of the mobile device to allow access by the second application to a network connected to the mobile device;
receiving, by the first application, a selection from the user to allow access by the second application to a network connected to the mobile device;
in response to receiving the selection from the user, permitting, by the first application, the second application to provide the second data to the server system.

6. The method of claim 1, wherein the data limiting condition comprises a time of day.

7. The method of claim 1, wherein the data limiting condition comprises a frequency of access to the network communication component by the second application.

8. The method of claim 1, wherein the data limiting condition comprises a data transmission rate or a data reception rate by the second application.

9. The method of claim 1, wherein the data limiting condition comprises a network connection type.

10. The method of claim 1, wherein the data limiting condition comprises a data transmission rate or data reception rate of a network to which the mobile device is connected.

11. The method of claim 1, wherein the data limiting condition comprises a network connection type and a data transmission rate or data reception rate of a network to which the mobile device is connected.

12. A mobile device comprising:
a processor;
a display;
a network communication component; and
a non-transitory, computer-readable medium in communication with the processor, the display, and the network communication component, and storing instructions that when executed by the processor cause the mobile device to perform operations comprising:
receiving, by the first application executing on the mobile device from a second application executing on the mobile device, a first request to provide a first data via the network communication component to a server system that is remote from the mobile device;
determining, by the first application, that a data limiting condition associated with the second application has been satisfied;
in response to the determination that the data limiting condition has been satisfied, preventing, by the first application, access by the second application to the network communication component; and
in response to the determination that the data limiting condition has been satisfied, providing, by the first application, a prompt on the display to allow a user to permit the second application to access a network connected to the mobile device.

13. The mobile device of claim 12, the operations further comprising:
receiving, by the first application, a selection from a user to block access by the second application to the network connected to the mobile device.

14. The mobile device of claim 12, the operations further comprising:
receiving, by the first application, a selection from a user to allow access by the second application to the network connected to the mobile device; and
in response to receiving the selection from the user, permitting, by the first application, the second application to provide the first data via the network communication component to the server system.

15. The mobile device of claim 12, the operations further comprising:
receiving, by the first application, a second data via an application programming interface that is in communication with a server of the network;
determining, by the first application based on the second data, a quantity of data transmitted or received by the mobile device via the network,
wherein determining the data limiting condition has been satisfied is based on the quantity of data.

16. The mobile device of claim 12, the operations further comprising:
prior to receiving the first request, receiving, by the first application, an indicator of a quantity of data purchased by a user of the mobile device; and
determining a threshold quantity based on the indicator,
wherein determining the data limiting condition has been satisfied comprises determining that a quantity of data sent and/or received by the mobile device exceeds the threshold quantity.

17. The mobile device of claim 12, wherein the first application has a dependency on a service configured to provide a virtual private network connection for the mobile device.

18. The mobile device of claim 12, wherein the first application comprises a policy service of an operating system executing on the mobile device.

19. A non-transitory, computer-readable medium storing instructions that when executed by a processor of a mobile device cause the mobile device to perform operations comprising:
receiving, at a first application executing on the mobile device from a second application executing on the mobile device, a first request to provide a first data via a network communication component of the mobile device to a server system that is remote from the mobile device;
determining, by the first application, that a quantity of requests within a period of time to provide data to and/or from the second application via the network communication component exceeds a first threshold;
determining, by the first application, that a quality of service rating of a network to which the network communication component is connected exceeds a second threshold;
in response to the determination that the first threshold and the second threshold have been exceeded, preventing, by the first application, access by the second application to the network communication component.

20. The non-transitory, computer-readable medium of claim 19, wherein the quality of service rating comprises at least one selected from the group consisting of: a quantity of total data passing through the network in a period of time, a quantity of packets dropped by the network in a period of time, a quantity of blocked network connection attempts in a period of time, a quantity of que delay in the network in a period of time, a net bit rate of the network, and a signal strength of the network.
